(19) United States
(12) Patent Application Publication
(10) Pub. No.: US 2016/0001712 A1
(43) Pub. Date: Jan. 7, 2016

(54) SWITCHING METHOD AND COMPUTER SYSTEM BASED ON SIGNAL INTENSITY

(71) Applicant: Wistron Corporation, New Taipei City (TW)

(72) Inventors: Chia-Lung Hsu, New Taipei City (TW); Po-Cheng Chen, New Taipei City (TW); Ming-Chih Chen, New Taipei City (TW)

(21) Appl. No.: 14/493,362

(22) Filed: Sep. 23, 2014

(30) Foreign Application Priority Data
Jul. 1, 2014 (TW) 103122720

(51) Int. Cl. B60R 11/02; H04N 21/442; H04N 21/414

(52) U.S. Cl. CPC B60R 11/0264; H04N 21/41422; B60R 11/0205; B60R 11/0211; H04N 21/44209; B60R 2011/0294

(57) ABSTRACT

A switching method for a multimedia player of a vehicle includes setting an operational mode for playing a predetermined signal; the multimedia player receiving a broadcasted signal to determine whether an intensity signal corresponding to the broadcasted signal exceeds a threshold value when the multimedia player processes a broadcast mode; and the multimedia player processing the operational mode for playing the predetermined signal when the intensity signal corresponding to the broadcasted signal is smaller than the threshold signal; wherein the predetermined signal is a source signal from a CD/DVD multimedia player, an audio multimedia player or a mobile device, or is a silent signal.

### BACKGROUND OF THE INVENTION

1. Field of the Invention

The present invention relates to a switching method and computer system for a multimedia player of a vehicle, and more particularly, to a switching method and computer system for a multimedia player of a vehicle, such that the multimedia player can be switched between a broadcast mode and an operational mode to upgrade a driving environment.

2. Description of the Prior Art

Generally, some drivers listen to broadcasted programs while driving vehicles for obtaining real-time traffic news or headlines, and some drivers listen to broadcasted music for reducing napping or having spiritual accompaniment. Once the driver passes through/to tunnels or suburban areas, the broadcasted program or the music thereof may have a poor signal intensity resulting in generation of noises or unstable/intermittent voices. If the driver tries to switch listening from the broadcasted program or the music thereof to other players or channels, the driver may be distracted from the driving or have no choice but tolerate the generation of noises or unstable/intermittent voices, which may also cause lowered attention on driving by the driver and lessen driving comfort.

Therefore, it has been an important issue to provide a switching method and computer system for a multimedia player of a vehicle, such that the multimedia player can be switched between a broadcast mode and an operational mode to upgrade a driving environment.

### SUMMARY OF THE INVENTION

It is an objective to provide a switching method and computer system for a multimedia player of a vehicle, such that the multimedia player can be switched between a broadcast mode and an operational mode to upgrade a driving environment.

The present invention discloses a switching method for a multimedia player of a vehicle. The switching method comprises setting an operational mode for playing a predetermined signal; the multimedia player receiving a broadcasted signal to determine whether an intensity signal corresponding to the broadcasted signal exceeds a threshold value when the multimedia player processes a broadcast mode; and the multimedia player processing the operational mode for playing the predetermined signal when the intensity signal corresponding to the broadcasted signal is smaller than the threshold signal; wherein the predetermined signal is a source signal from a CD/DVD multimedia player, an audio multimedia player or a mobile device, or the predetermined signal is a silent signal.

The present invention also discloses a computer system coupled to a multimedia player of a vehicle. The computer system comprises a central processing unit; and a storage device, coupled to the central processing unit and storing a programming code, the programming code is utilized to process a switching method. The switching method comprises setting an operational mode for playing a predetermined signal; the multimedia player receiving a broadcasted signal to determine whether an intensity signal corresponding to the broadcasted signal exceeds a threshold value when the multimedia player processes a broadcast mode; and the multimedia player processing the operational mode for playing the predetermined signal when the intensity signal corresponding to the broadcasted signal is smaller than the threshold signal; wherein the predetermined signal is a source signal from a CD/DVD multimedia player, an audio multimedia player or a mobile device, or the predetermined signal is a silent signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a multimedia player coupled to a computer system according to an embodiment of the invention.

FIG. 2 illustrates a flow chart of a switching process according to an embodiment of the invention.

FIG. 3 illustrates a schematic diagram of a user interface according to an embodiment of the invention.

FIG. 4 illustrates a schematic diagram of another user interface according to an embodiment of the invention.

FIG. 5 illustrates a schematic diagram of another user interface according to an embodiment of the invention.

FIG. 6 illustrates a schematic diagram of another user interface according to an embodiment of the invention.

FIG. 7 illustrates a flow chart of a switching process according to an embodiment of the invention.

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claim is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

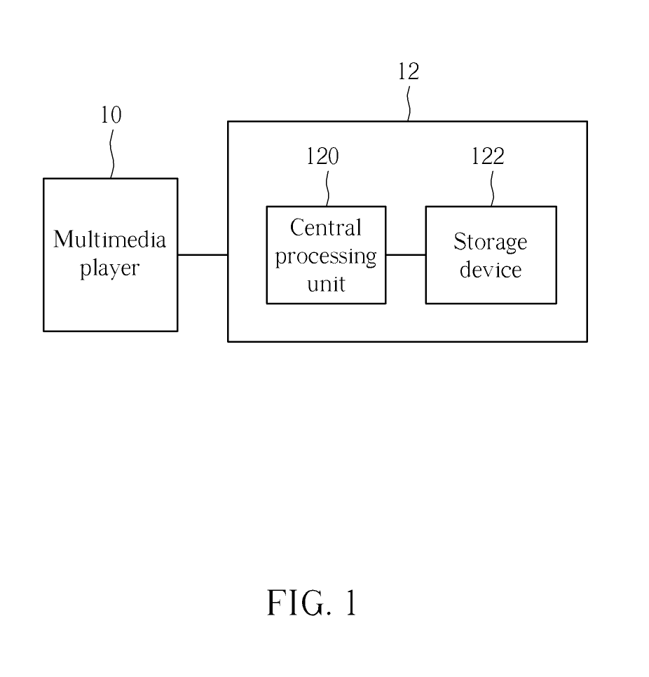

FIG. 1 illustrates a schematic diagram of a multimedia player 10 coupled to a computer system 12 according to an embodiment of the invention. The multimedia player 10 is disposed inside a vehicle (not shown in the figure), and is operated to play broadcasted signals while a driver drives the vehicle. The multimedia player 10 is also coupled to receive a source signal from a CD/DVD multimedia player, an audio multimedia player (e.g. a MP3 player) or a mobile device. The multimedia player 10 can be integrated with a driving navigation device, e.g. global positioning system (GPS) or other types of positioning modules, which is not limiting the scope of the invention. The computer system 12 has a basic structure comprising a main board, a processing unit, a memory, a hard disk, a south-bridge module, a north-bridge module, and etc., and should be well known to those skilled in the art. For the brevity, FIG. 1 of the invention only illustrates a central processing unit 120 and a storage device 122 of the computer system 12. The storage device 122 can be, but not limited to, read-only memory (ROM), random-access memory (RAM), flash, floppy disk, hardware disk, compact disc, USB flash drive, tape, database accessed via the Internet, or other types of storage medium known to those skilled in the art, to store a programming code, such that the central processing unit 120 can be utilized to process the programming code to operate a switching method for the multimedia player 10.

In the embodiment of the invention, the multimedia player 10 can be adaptively switched between a broadcast mode and an operational mode to provide a comfortable driving environment for the driver, wherein the broadcast mode is operated to receive a broadcasted signal for playing a broadcasted program/music, and the operational mode is operated to receive a source signal from the CD/DVD multimedia player, the audio multimedia player or the mobile device, or may play a silent signal. In other words, the embodiment of the invention provides the switching method for the driver to be utilized in the situation that while the driver passes through/to tunnels or suburban areas to have poor signal intensities of the broadcasted program or the music thereof, the processing broadcast mode can be adaptively switched to other operational modes with different players/voice channels, such that the driver can avoid distraction from the driving to upgrade/improve driving comfort of the vehicle.

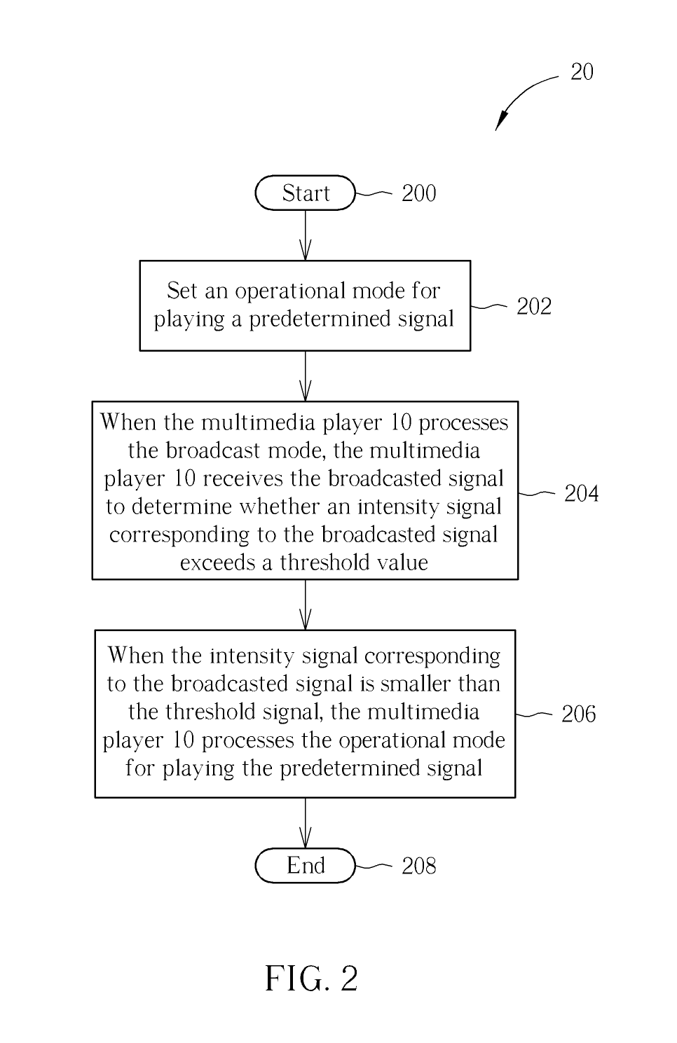

Furthermore, the switching method of the multimedia player 10 of the invention can be summarized as a switching process 20, as shown in FIG. 2, to be stored in the storage device 122. The switching process 20 includes the following steps:

Step 200: Start.

Step 202: Set an operational mode for playing a predetermined signal.

Step 204: When the multimedia player 10 processes the broadcast mode, the multimedia player 10 receives the broadcasted signal to determine whether an intensity signal corresponding to the broadcasted signal exceeds a threshold value.

Step 206: When the intensity signal corresponding to the broadcasted signal is smaller than the threshold signal, the multimedia player 10 processes the operational mode for playing the predetermined signal.

Step 208: End.

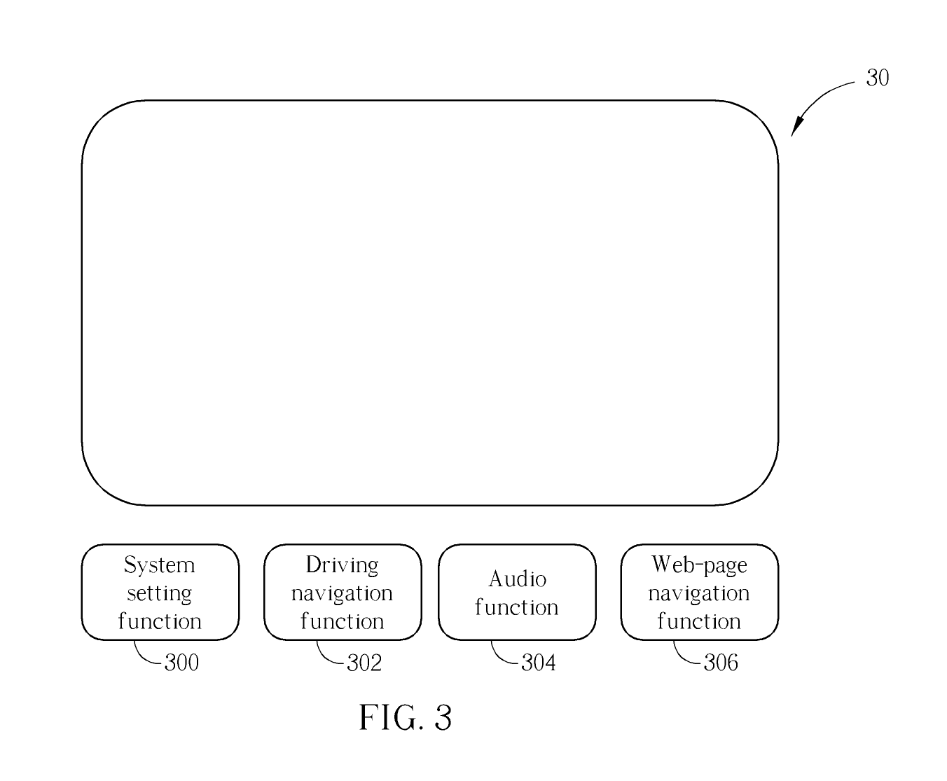

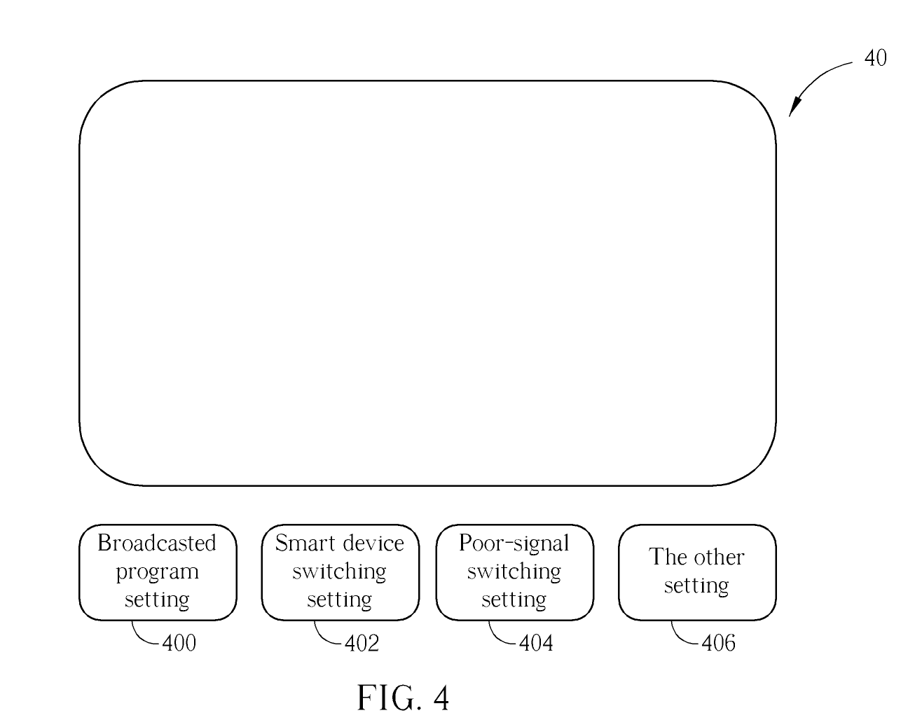

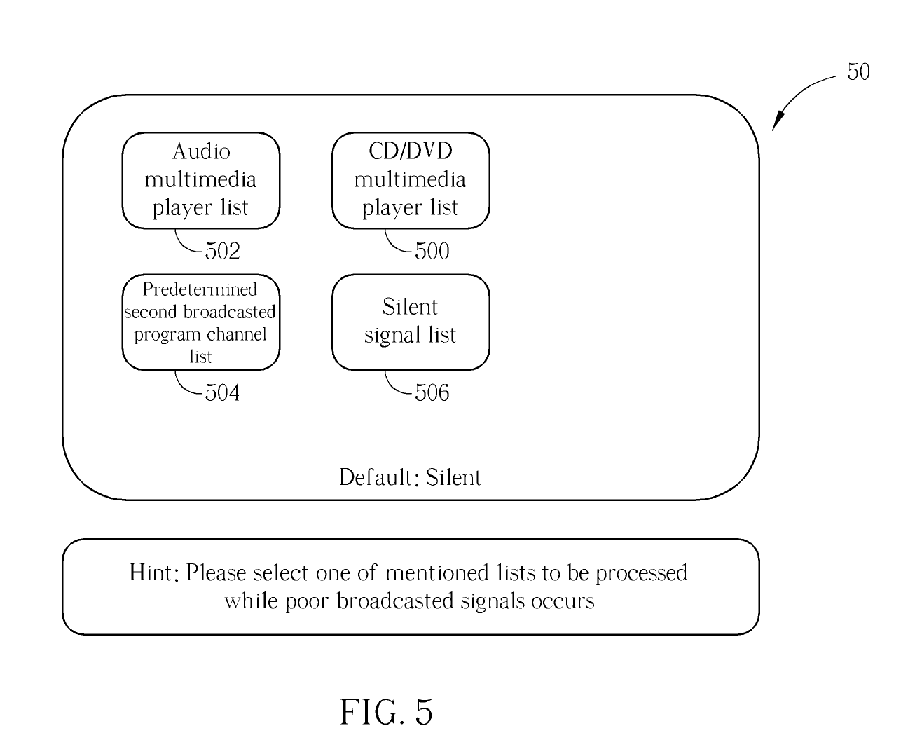

In step 202, the embodiment of the invention also utilizes a user interface to set the operational mode, such that the driver can determine the predetermined signal to be the source signal from one of the CD/DVD multimedia player, the audio multimedia player or the mobile device, or to be the silent signal. FIG. 3 illustrates a schematic diagram of a user interface 30 according to an embodiment of the invention. As shown in FIG. 3, the multimedia player 10 processes a predetermined operation when being initiated, and the user interface 30 can be utilized to display installed functions of the multimedia player 10, wherein the functions can be a driving navigation function 302, an audio function 304 or a web-page navigation function 306. Also, a system setting function 300 can be also shown on the user interface 30. When a user presses/initiates the system setting function 300, the user interface 30 enters into a plurality of sub display pages to sequentially set/determine different functions of the multimedia player 10. For example, FIG. 4 of the invention illustrates another user interface 40 and comprises a broadcasted program setting 400, a smart device switching setting 402, a poor-signal switching setting 404 or the other setting 406. The broadcasted program setting 400 is utilized to set/determine classified selections of the broadcasted signal, e.g. a broadcasted program, a broadcasted channel, a broadcasted period, a broadcasted show or a broadcasted program host, etc. The smart device switching setting 402 is utilized to set/determine a playing selection from the CD/DVD multimedia player, the audio multimedia player (e.g. MP3 player) or the mobile device. The poor-signal switching setting 404 is utilized to set/determine selection lists to be switched for the multimedia player 10 while the driver drives through the tunnels or suburban with poor signal intensities, and the selection lists can be further understood in FIG. 5 of the invention.

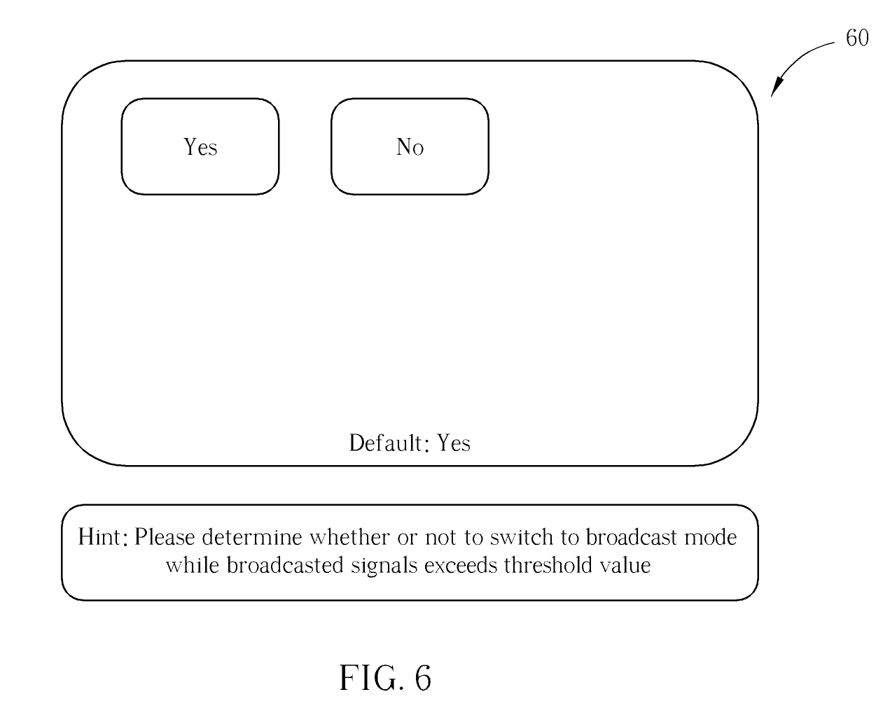

In detail, FIG. 5 illustrates another user interface 50 and comprises the selection lists to be switched for the multimedia player 10, e.g. a CD/DVD multimedia player list 500, an audio multimedia player list 502, a predetermined second broadcasted program channel list 504 or a silent signal list 506. If the driver does not set/determine the related setting of the poor-signal switching setting 404, a default of the multimedia player 10 can be the silent signal list 506. FIG. 6 illustrates another user interface 60 according to an embodiment of the invention. When the driver finishes the related setting of the poor-signal switching setting 404, the multimedia player 10 can show the user interface 60 shown in FIG. 6 to tell the driver whether or not to further switch to the broadcasted program setting 400 to continuously play the broadcasted signal. If the driver does not set/determine the related setting of the user interface 60, the default of the user interface 60 will control the multimedia player 10 to automatically switch to play the broadcasted signal. Those skilled in the art can modify/adjust the user interface 30 of the embodiment to adaptively add/delete sub display pages or functional lists for extending other operational functions according to different vehicle equipment, which is also in the scope of the invention.

In step 204, when the multimedia player 10 processes the broadcast mode to play the broadcasted signal, the multimedia player 10 receiving the broadcasted signal determines whether the intensity signal corresponding to the broadcasted signal exceeds the threshold value. In other words, if the intensity signal of the broadcasted signal exceeds the threshold value, the multimedia player 10 continuously processes the broadcast mode to play the broadcasted signal; if the intensity signal of the broadcasted signal does not exceed the threshold value, step 206 is processed.

In step 206, when the intensity signal corresponding to the broadcasted signal is smaller than the threshold signal, the multimedia player 10 processes the operational mode for playing the predetermined signal. The predetermined signal is predetermined in step 202 via the user interface 50, and can be one of the CD/DVD multimedia player list 500, the audio multimedia player list 502 (e.g. MP3 player), the predetermined second broadcasted program channel list 504 and the silent signal list 506. Accordingly, when the driver drives the vehicle through/to tunnels or suburban areas with the poor broadcasted program signal (i.e. the intensity signal being smaller than the threshold value), the multimedia player 10 of the embodiment will process the switching process 20 to play the source signal from one of the CD/DVD multimedia player, the MP3 player, the predetermined second broadcasted program channel and other players, or the multimedia player 10 maintains silent or plays the silent signal (i.e. switch to a silent mode), such that the driver will not be distracted due to the poor broadcasted signal and have a better driving environment.

Furthermore, step 206 can also cooperate with another determination mechanism/process. When the driver leaves the tunnels/suburban areas and the signal intensity of the broadcasted signal exceeds the threshold value (i.e. the broadcasted signal is good enough for listening), the multimedia player 10 can automatically switch from the operational mode to the broadcast mode via the determination mechanism/process (i.e. operating as a prompt/notification message in the user interface 600). In other words, the multimedia player 10 can continuously determine whether the signal intensity of the broadcasted signal exceeds the threshold value for listening. Once the broadcasted signal is good enough for listening and the driver has predetermined the switching operation in advance, the multimedia player 10 will automatically switch to the broadcast mode without manually setting the user interface 30 via surfing through the plurality of sub display pages to select desired broadcasted programs/music, which can significantly improve the controlling ability for the drivers.

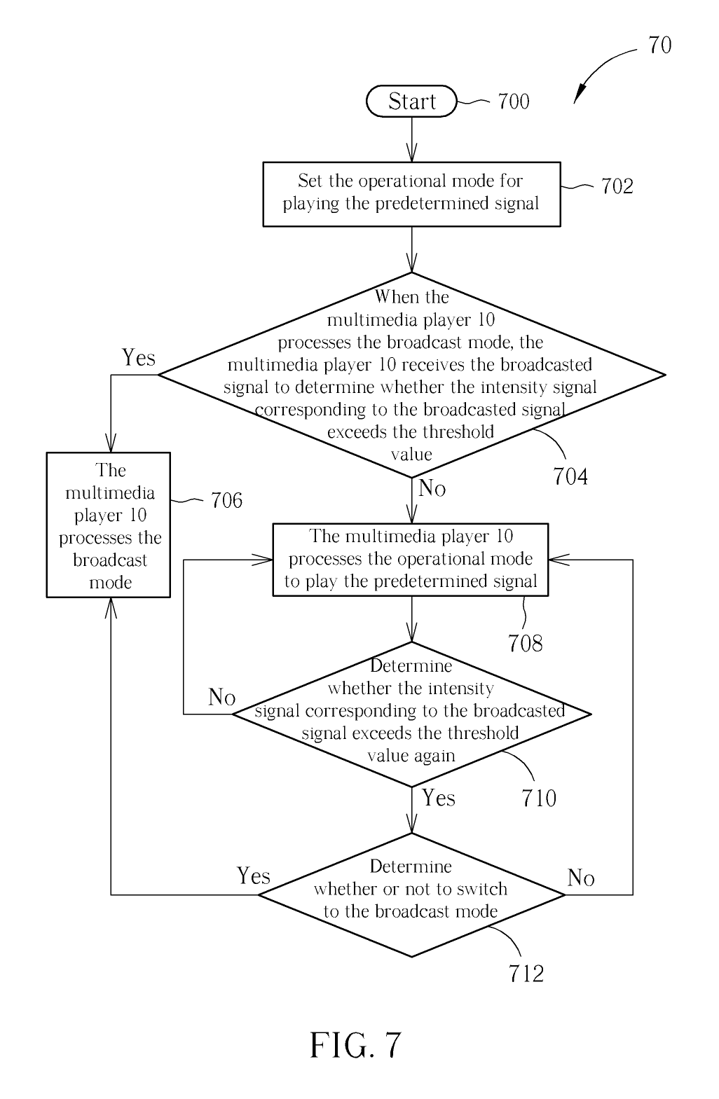

Furthermore, another switching method of the multimedia player 10 of the invention can be summarized as a switching process 70, as shown in FIG. 7, to be stored in the storage device 122. The switching process 70 includes the following steps:

Step 700: Start.

Step 702: Set the operational mode for playing the predetermined signal.

Step 704: When the multimedia player 10 processes the broadcast mode, the multimedia player 10 receives the broadcasted signal to determine whether the intensity signal corresponding to the broadcasted signal exceeds the threshold value. If the broadcasted signal exceeds the threshold value, process step 706; otherwise, process 708.

Step 706: The multimedia player 10 processes the broadcast mode.

Step 708: The multimedia player 10 processes the operational mode to play the predetermined signal.

Step 710: Determine whether the intensity signal corresponding to the broadcasted signal exceeds the threshold value again. If the broadcasted signal exceeds the threshold value, process step 712; otherwise, process 708.

Step 712: Determine whether or not to switch to the broadcast mode. If it is determined to switch to the broadcast mode, process step 706; otherwise, process 708.

Step 700 to Step 712 of switching process 70 does clearly clarify when the multimedia player 10 processes the switching operation between the broadcast mode and the operational mode, and detailed operations thereof can be understood via the switching process 20 and related paragraphs thereof, which is not described hereinafter for brevity. Besides, the multimedia player 10 of the embodiment can be further coupled to a positioning module (not shown in the figure). Accordingly, a position coordinate of the vehicle sensed by the positioning module can be utilized to determine whether the driver locates in one of the plurality of areas where the signal intensity of the broadcasted signal is smaller than the threshold value. Once the driver enters one of the plurality of areas, the positioning module generates an automatic switching signal, such that the multimedia player 10 can be switch from the broadcast mode to the operational mode to play other voice source signals. When the driver leaves the area, the positioning module also generates the automatic switching signal again, such that the multimedia player 10 can be switched to the broadcast mode.

The automatic switching signal of the embodiment can cooperate with the user interfaces 30-60. In brief, in the presetting operation, the driver can determine whether or not to process the switching operations while entering into the plurality of areas. Also, the driver can determine whether or not to maintain the operational mode or to switch to the broadcast mode while leaving the plurality of areas. Further, a prompt message can also be utilized to cooperate with the operations of the user interfaces 30-60, such that the driver is not necessary to re-enter the sub display pages for another selection/determination, which is also in the scope of the invention.

Noticeably, the broadcasted signal of the invention is not limited to conventional amplitude modulation (AM) signals or frequency modulation (FM) signals. In order to complying with string data by wireless transmission, the multimedia player 10 can further install a network module to correspondingly receive a network signal, and the switching process 20 can be also utilized to receive the network signal, which is also in the scope of the invention. The threshold value of the invention corresponds to a minimum listening quality value that the driver can easily sense while driving. Those skilled in the art can modify/adjust the conception that comparing the signal intensity of the broadcasted signal and the threshold value to another solution, e.g. simultaneously comparing a plurality of broadcasted signals in an operational frequency range to find out a maximum value of one of the plurality of broadcasted signals. Accordingly, the multimedia player 10 correspondingly receives the one of the plurality of broadcasted signals with the maximum value for playing, or the broadcasted program/signal can be adaptively selected/switched by the multimedia player 10 in different areas via the cooperation of the positioning module, which is also in the scope of the invention.

The switching process 20 of the embodiment renders the teaching that the driver can preset the switching selections/operations of the multimedia player 10 in advance. When the driver has a new driving path to receive the broadcasted signal (or the network signal) being smaller than the threshold value, the multimedia player 10 can be cooperated with the positioning module to add areas/spots connected by the new driving path to be poor-signal areas. Accordingly, the multimedia player 10 can be set to avoid the utilization of the broadcast mode in advance while entering into one of the poor-signal areas, or the positioning module can be utilized to calculate another driving path for the driver to replace the original driving path passing one or more poor-signal areas, which improves the driving environment of the vehicle as well as renders another more intelligent operation of the multimedia player 10.

In summary, the embodiments of the invention provide a switching method for a multimedia player of a vehicle. The driver can preset operations to determine the switching options of the multimedia player, such that the multimedia player can be adaptively switched between the broadcast mode and the operational mode. Also, a positioning module can be utilized to record driving paths, so as to provide another smart/intelligent operation to automatically avoid areas with the poor broadcasted signals, or in advance to calculate other replacement driving paths, which can effectively reduce the situation as distracting the driver to improve/enlarge the comfort of driving the vehicle.

Those skilled in the art will readily observe that numerous modifications and alterations of the device and method may be made while retaining the teachings of the invention. Accordingly, the above disclosure should be construed as limited only by the metes and bounds of the appended claims.

1. A switching method for a multimedia player of a vehicle, the switching method comprising:
setting an operational mode for playing a predetermined signal;
the multimedia player receiving a broadcasted signal to determine whether an intensity signal corresponding to the broadcasted signal exceeds a threshold value when the multimedia player processes a broadcast mode; and
the multimedia player processing the operational mode for playing the predetermined signal when the intensity signal corresponding to the broadcasted signal is smaller than the threshold signal;
wherein the predetermined signal is a source signal not retrieved from a communication network, and retrieved from a CD/DVD multimedia player, an audio multimedia player or a mobile device, or the predetermined signal is a silent signal.

2. The switching method of claim 1, further comprising when the multimedia player is initiated, processing a predetermined operation to set the predetermined signal to be the source signal from the CD/DVD multimedia player, the audio multimedia player or the mobile device, or to set the predetermined signal to be the silent signal.

3. The switching method of claim 1, further comprising utilizing a user interface to set the predetermined signal, and to set the operational mode or an operational content of the broadcast mode.

4. The switching method of claim 1, further comprising switching the multimedia player from the broadcast mode to the operational mode according to an automatic switching signal of a positioning module.

5. The switching method of claim 4, further comprising utilizing the positioning module to record an area where the intensity signal corresponding to the broadcasted signal is smaller than the threshold value, and when the vehicle enters into the area and the multimedia player is operated under the broadcast mode, the positioning module generates the automatic switching signal to make the multimedia player process the operational mode.

6. The switching method of claim 4, further comprising when the vehicle leaves an area and the multimedia player is operated under the operational mode, determining whether the multimedia player is switched to the broadcast mode or maintained under the operational mode.

7. The switching method of claim 4, further comprising when the multimedia player is operated under the broadcast mode and the intensity signal corresponding to the broadcasted signal exceeds the threshold value, the multimedia player continues processing the broadcast mode.

8. A computer system, coupled to a multimedia player of a vehicle, the computer system comprising:
a central processing unit; and
a storage device, coupled to the central processing unit and storing a programming code, the programming code is utilized to process a switching method, the switching method comprising:
setting an operational mode for playing a predetermined signal;
the multimedia player receiving a broadcasted signal to determine whether an intensity signal corresponding to the broadcasted signal exceeds a threshold value when the multimedia player processes a broadcast mode; and
the multimedia player processing the operational mode for playing the predetermined signal when the intensity signal corresponding to the broadcasted signal is smaller than the threshold signal;
wherein the predetermined signal is a source signal not retrieved from a communication network, and retrieved from a CD/DVD multimedia player, an audio multimedia player or a mobile device, or the predetermined signal is a silent signal.

9. The computer system of claim 8, wherein the multimedia player is electrically connected to the CD/DVD multimedia player, the audio multimedia player or the mobile device, and the switching method further comprises when the multimedia player is initiated, processing a predetermined operation to set the predetermined signal to be the source signal from the CD/DVD multimedia player, the audio multimedia player or the mobile device, or to set the predetermined signal to be the silent signal.

10. The computer system of claim 8, wherein the multimedia player further comprises a user interface to set the predetermined signal, and to set the operational mode or an operational content of the broadcast mode.

11. The computer system of claim 8, wherein the multimedia player is further coupled to a positioning module, and the switching method further comprises switching the multimedia player from the broadcast mode to the operational mode according to an automatic switching signal of the positioning module.

12. The computer system of claim 11, wherein the switching method further comprises utilizing the positioning module to record an area where the intensity signal corresponding to the broadcasted signal is smaller than the threshold value, and when the vehicle enters into the area and the multimedia player is operated under the broadcast mode, the positioning module generates the automatic switching signal to make the multimedia player process the operational mode.

13. The computer system of claim 11, wherein the switching method further comprises when the vehicle leaves an area and the multimedia player is operated under the operational mode, determining whether the multimedia player is switched to the broadcast mode or maintained under the operational mode.

14. The computer system of claim 8, wherein the switching method further comprises when the multimedia player is operated under the broadcast mode and the intensity signal corresponding to the broadcasted signal exceeds the threshold value, the multimedia player continues processing the broadcast mode.
